(19) United States
(12) Patent Application Publication
(10) Pub. No.: US 2025/0214477 A1
(43) Pub. Date: Jul. 3, 2025

(54) MOBILE CHARGING SYSTEM AND METHOD

(71) Applicants: HYUNDAI MOTOR COMPANY, Seoul (KR); KIA CORPORATION, Seoul (KR)

(72) Inventors: Hyuntek Lim, Hwaseong-si (KR); Dong Hwan Kwak, Hwaseong-si (KR); Sanghyeon Oh, Hwaseong-si (KR)

(73) Assignees: HYUNDAI MOTOR COMPANY, Seoul (KR); KIA CORPORATION, Seoul (KR)

(21) Appl. No.: 18/787,317

(22) Filed: Jul. 29, 2024

(30) Foreign Application Priority Data
Dec. 27, 2023 (KR) 10-2023-0193587

(51) Int. Cl. B60L 53/68; B60L 53/35; B60L 53/57; H02J 7/00

(52) U.S. Cl. CPC B60L 53/68; B60L 53/35; B60L 53/57; H02J 7/00032; H02J 7/0042

(57) ABSTRACT

A mobile charging system includes: a charging station; a main charging device including a first energy storage device configured to store electrical energy or discharge the stored electrical energy, and a first driving unit providing locomotion by using the electrical energy stored in the first energy storage device; at least one auxiliary charging device including a second energy storage device configured to store electrical energy or discharge the stored electrical energy, and a second driving unit providing locomotion by using the electrical energy stored in the second energy storage device; and a control server communicably connected to the main charging device and at least one auxiliary charging device and configured to transmit a charging command to the main charging device to move the main charging device to the charging demanding device and charge the charging demanding device. Further, a mobile charging method using the mobile charging system is provided.

### CROSS-REFERENCE TO RELATED APPLICATION

This application claims priority to and the benefit of Korean Patent Application No. 10-2023-0193587 filed in the Korean Intellectual Property Office on Dec. 27, 2023, the entire contents of which are incorporated herein by reference.

### BACKGROUND

### (a) Technical Field

The present disclosure relates to a charging system and a charging method, and more particularly to a mobile charging system and a charging method using a movable charging device.

### (b) Description of Related Art

In recent years, use of eco-friendly vehicles, including electric vehicles, has been gradually increasing. Instead of burning fuel, the eco-friendly vehicle uses electrical energy stored in a battery to run, so the capacity of the battery determines a driving range of the eco-friendly vehicle. In other words, as the capacity of the battery is greater, the driving range of the eco-friendly vehicle increases.

Typically, in the eco-friendly vehicle, the mounting space for the battery is limited, so the capacity of the battery is also limited. As a result, the driving range of the eco-friendly vehicle is relatively short and the battery needs to be charged relatively frequently. In addition, a charging time of the battery is relatively long, so users want to charge the battery in a parking lot where the eco-friendly vehicle is not used for a significant period of time.

However, due to lack of charging facilities, when the charging facilities are occupied by other eco-friendly vehicles, the vehicle has to wait for a long time before charging, and in certain circumstances, the vehicle has to be used without charging.

To solve this inconvenience, it is proposed to provide a mobile charging device in a parking lot instead of a fixed charging facility. The mobile charging device moves to the vehicle parked in a parking area and charges the vehicle. However, since the vehicle needs to be charged with energy stored in an Energy Storage System (ESS), the ESS needs to have a large capacity, and the mobile charging device needs to be large to accommodate the ESS with large capacity. Therefore, the movement of the mobile charging device is limited in a tight parking space and the movement of other vehicles are impeded. In addition, the number of mobile charging devices that may be placed in the tight parking space is limited, and the mobile charging devices themselves may consume a lot of energy to move. Furthermore, the number of vehicles that are chargeable simultaneously is limited to the number of mobile charging devices. Therefore, it is insufficient to solve the inconvenience of typical charging facilities unless the number of mobile charging devices is sufficiently increased.

The matters described in the description of the related art are prepared to enhance the understanding of the background of the present disclosure, and may include matters that are not already known to those having ordinary skill in the art to which the present technology belongs. In other words, the statements in this BACKGROUND section merely provide background information related to the present disclosure and may not constitute prior art.

### SUMMARY

The present disclosure provides a mobile charging system and a method of charging using the same, in which not only can the charging demanding device be charged using only the main charging device, but also the charging demanding device can be charged by using at least one auxiliary charging device electrically connected to the main charging device together with the main charging device.

The present disclosure also provides a mobile charging system and a charging method, in which an autonomously movable main charging device alone may charge a charging demanding device, as well as at least one auxiliary charging device, which is also autonomously movable and electrically connected to the main charging device, may be used together with the main charging device to charge the charging demanding device.

An embodiment of the present disclosure provides a mobile charging system. The mobile charging system includes: a charging station fixedly mounted at a predetermined location in a charging space where a charging demanding device is chargeable (e.g., at a predetermined location in a charging station that allows a charging demanding device to be located therein for charging); and a main charging device including a first energy storage device capable of storing electrical energy or discharging the stored electrical energy, and a first driving unit providing locomotion by using the electrical energy stored in the first energy storage device. The main charging device can be connected to the charging station to store the electrical energy of the charging station in the first energy storage device or connected to the charging demanding device to charge the charging demanding device with the electrical energy stored in the first energy storage device. The mobile charging system further includes at least one auxiliary charging device including a second energy storage device capable of storing electrical energy or discharging the stored electrical energy, and a second driving unit providing locomotion by using the electrical energy stored in the second energy storage device. The at least one auxiliary charging device can be connected to the charging station to store the electrical energy of the charging station in the second energy storage device or connected to the main charging device to charge the charging demanding device with the electrical energy stored in the second energy storage device via the main charging device. The mobile charging system further includes a control server communicably connected to the main charging device and at least one auxiliary charging device. The mobile charging system is configured to transmit a charging command to the main charging device to move the main charging device to the charging demanding device and charge the charging demanding device.

The control server may be further configured to: in response to receiving a status of the main charging device from the main charging device, determine whether the charging demanding device is fully chargeable by the main charging device alone; and, in response to determining that the charging demanding device is not fully chargeable by the main charging device alone, transmit the charging command to the at least one auxiliary charging device to move the at least one auxiliary charging device to the main charging device and charge the charging demanding device via the main charging device.

The control server may be further configured to: detect an available auxiliary charging device prior to transmitting the charging command to the at least one auxiliary charging device; determine whether the charging demanding device is fully chargeable with the available auxiliary charging device; and, in response to determining that the charging demanding device is fully chargeable with the available auxiliary charging device, proceed with a simultaneous charging method in which the at least one available auxiliary charging device is simultaneously engaged in charging.

The control server may be further configured to proceed with a circular charging method in which the at least one available auxiliary charging device is sequentially engaged in charging in response to determining that the charging demanding device is not fully chargeable by the available auxiliary charging device.

The mobile charging system may further include a user interface communicably connected to the control server to be configured to transmit a charging demand to the control server and to receive charging information from the control server.

The user interface may be further configured to display the charging information received from the control server.

The main charging device may further include a first docking unit mounted to the main charging device and connectable to the charging station or the charging demanding device. The first docking unit may extend from the main charging device. The main charging device may further include a first connection unit provided on the main charging device and spaced apart from the first docking unit to allow the at least one auxiliary charging device to be connected in a state where the main charging device is connected to the charging demanding device via the first docking unit.

The first docking unit may be automatically or manually connectable to the charging station or the charging demanding device.

Each auxiliary charging device may further include a second docking unit mounted to the auxiliary charging device and connectable to the charging station, the main charging device, or another auxiliary charging device. The second decking unit may extend from the auxiliary charging device. Each auxiliary charging device may further include a second connection unit provided on the auxiliary charging device and spaced apart from the second docking unit to allow another auxiliary charging device to be connected in a state where the auxiliary charging device is connected to the main charging device or another auxiliary charging device via the second docking unit.

The second docking unit may be automatically or manually connectable to the charging station, the main charging device, or another auxiliary charging device.

The main charging device or the at least one auxiliary charging device may autonomously drive.

An embodiment of the present disclosure provides a mobile charging method. The mobile charging method includes: receiving, by a control server, a charging demand including at least one of location information or an amount of charging demanded of a charging demanding device; moving and docking a main charging device to the charging demanding device by transmitting, by the control server, a charging command including at least one of the location information or the amount of charging demanded of the charging demanding device; determining, by the main charging device or the control server, whether the main charging device alone is capable of fully charging the charging demanding device; detecting, by the control server, an available auxiliary charging device in response to determining that the main charging device alone is not capable of fully charging the charging demanding device; and charging the charging demanding device with the available auxiliary charging device via the main charging device by transmitting, by the control server, the charging command including location information of the main charging device to the available auxiliary charging device.

Charging the charging demanding device with the available auxiliary charging device via the main charging device may include: determining whether the charging demanding device is fully chargeable with the available auxiliary charging device; and in response to determining that the charging demanding device is fully chargeable with the available auxiliary charging device, proceeding with a simultaneous charging method in which the at least one available auxiliary charging device is simultaneously engaged in charging.

Proceeding with a simultaneous charging method may include: selecting the available auxiliary charging device required to fully charge the charging demanding device; and connecting the selected available auxiliary charging device to the main charging device or another selected available auxiliary charging device to allow the main charging device and the selected available auxiliary charging device to simultaneously charge the charging demanding device.

Charging of the charging demanding device with the available auxiliary charging device via the main charging device may further include in response to determining that the charging demanding device is not fully chargeable with the available auxiliary charging device, proceeding with a circular charging method in which the at least one available auxiliary charging device is sequentially engaged in charging.

Proceeding with a circular charging method may include: connecting the at least one available auxiliary charging device to the main charging device or another available auxiliary device connected to the main charging device to charge the charging demanding device with the main charging device and the at least one available auxiliary charging device; disconnecting the at least one available auxiliary charging device from the main charging device or the another available auxiliary device connected to the main charging device; and connecting at least one other available auxiliary charging device to the main charging device or the another available auxiliary device connected to the main charging device to charge the charging demanding device with the main charging device and the at least one other available auxiliary device.

The mobile charging method may further include: transmitting the charging demand to the control server by a user interface communicably connected with the control server; and receiving, by the user interface, charging information from the control server.

The mobile charging method may further include displaying, by the user interface, the charging information received from the control server.

The main charging device or the at least one auxiliary charging device may autonomously drive.

According to an embodiment of the present disclosure, it is possible to charge the charging demanding device with the main charging device alone, and also it is possible to charge the charging demanding device by using at least one auxiliary charging device electrically connected to the main charging device together with the main charging device. As a result, there is no need to increase the capacity of the main charging device and the auxiliary charging device, which reduces the size of the main charging device and the auxiliary charging device and improves movability in narrow spaces, such as parking lots where multiple vehicles are parked.

In addition, the main charging device and the auxiliary charging device are not large, so that it is possible to increase the number of main charging devices and auxiliary charging devices disposed even in a narrow space, thereby increasing the number of vehicles that is chargeable simultaneously.

Furthermore, the main charging device and the auxiliary charging device are combined to charge the vehicles, enabling efficient operation of the charging system through various charging strategies.

Other effects that may be obtained or anticipated by the embodiments of the present disclosure are disclosed, directly or by implication, in the detailed description of the present disclosure. In other words, various effects predicted according to the embodiments of the present disclosure have been disclosed in the detailed description which is to be given below.

### BRIEF DESCRIPTION OF THE DRAWINGS

Embodiments of the present disclosure may be better understood by reference to the following description linked to the same or functionally similar elements of similar reference numerals.

FIG. 1 is a schematic diagram of a mobile charging system according to an embodiment of the present disclosure.

FIG. 2 is a block diagram of a mobile charging system according to an embodiment of the present disclosure, with respect to a main charging device.

FIG. 3 is a block diagram of a mobile charging system according to an embodiment of the present disclosure, with respect to an auxiliary charging device.

FIG. 4 schematically illustrates a communication state between components of a mobile charging system according to an embodiment of the present disclosure.

FIG. 5 is a flow diagram of a mobile charging method according to an embodiment of the present disclosure.

FIG. 6 is a diagram illustrating a simultaneous charging method according to an embodiment of the present disclosure.

FIG. 7 is a diagram illustrating a circular charging method according to an embodiment of the present disclosure.

It should be understood that the foregoing referenced drawings are not necessarily illustrated in accordance with the scale, and they present somewhat brief expression of various characteristics illustrating the basic principle of the present disclosure. For example, the specific design characteristics of the present disclosure including a specific dimension, direction, location, and shape may be partially determined by a particular intended application and use environment.

### DETAILED DESCRIPTION

The terms used herein are for the purpose of describing specific exemplary embodiments, and are not intended to limit the present disclosure. As used herein, singular expressions include plural expressions unless they have definitely opposite meanings. The terms “include” and/or “including” specify the presence of the mentioned characteristics, integers, steps, operations, constituent elements, and/or components when used in the present specification, but it should also be understood that this does not exclude the presence or addition of one or more of other characteristics, integers, steps, operations, constituent elements, components, and/or groups thereof. As used herein, the term “and/or” includes any one or all combinations of the associated and listed items.

As used herein, the term “vehicle” or “vehicular” or other similar terms are understood to include typical vehicles, including passenger cars including sport utility vehicles (SUVs), buses, trucks, and various commercial vehicles, and to include hybrid vehicles, electric vehicles, plug-in hybrid electric vehicles, hydrogen-powered vehicles, and other alternative fuel (for example, fuel derived from sources other than petroleum) vehicles. As mentioned in the present specification, a hybrid vehicle is a vehicle having two or more power sources, such as a gasoline-powered and electric-powered vehicle. A vehicle according to an embodiment of the present disclosure includes a manually driven vehicle as well as a vehicles that is driven more or less autonomously and/or automatically.

In addition, it is understood that one or more of the methods below or the aspects thereof may be executed by at least one or more controllers. The term “controller” may refer to a hardware device including a memory and a processor. The memory is configured to store program commands, and the processor is specially programmed so as to execute program commands to perform one or more processes described in more detail below. The controller may control operations of units, modules, components, devices, or similar matters thereof as described herein. Further, it is understood that the following methods may be executed by a device including a controller together with one or more other components as recognized by those having ordinary skill in the art.

Further, the controller of an embodiment of the present disclosure may be implemented as a non-transitory computer readable recording medium including program commands executable by a processor. Examples of the computer readable recording medium includes a read only memory (ROM), a random access memory (RAM), a compact disc (CD) ROM, magnetic tapes, floppy discs, flash drives, smart cards, and optical data storage devices, but the computer readable recording medium is not limited thereto. The computer readable recording medium may also be dispersed across the computer network to store and execute program commands by a distributed method, such as a telematics server or a controller arear network (CAN).

When a component, unit, controller, server, device, element, apparatus, or the like of the present disclosure is described as having a purpose or performing an operation, function, or the like, the component, unit, controller, server, device, element, apparatus, or the like should be considered herein as being “configured to” meet that purpose or to perform that operation or function. Each component, unit, controller, server, device, element, apparatus, and the like may separately embody or be included with a processor and a memory, such as a non-transitory computer readable media, as part of them.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Hereinbelow, embodiments of the present disclosure have been described in detail with reference to the accompanying drawings.

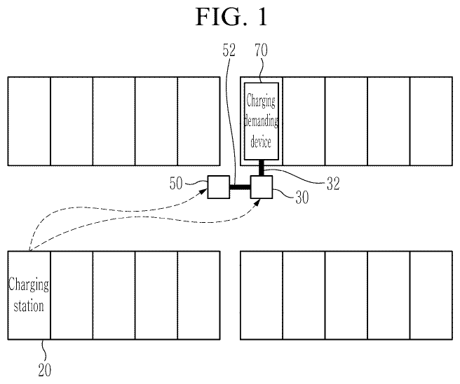

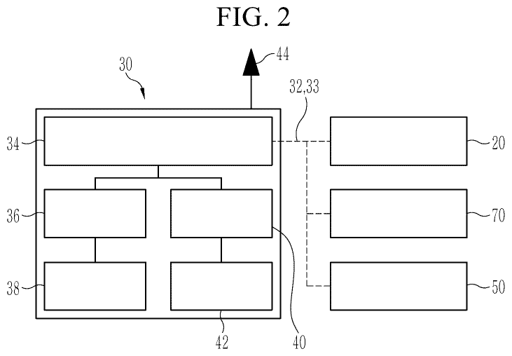

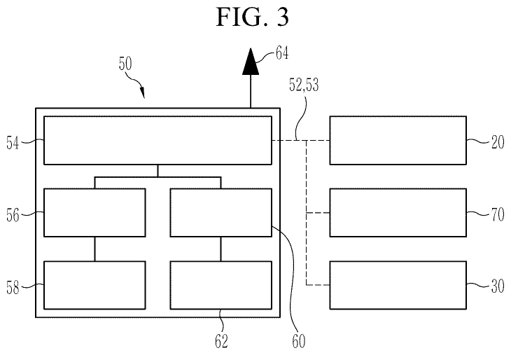

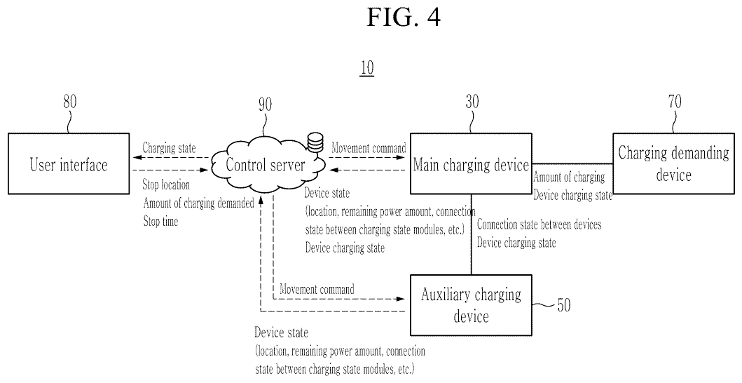

FIG. 1 is a schematic diagram of a mobile charging system according to an embodiment of the present disclosure, FIG. 2 is a block diagram of a mobile charging system according to an embodiment of the present disclosure, with respect to a main charging device, FIG. 3 is a block diagram of a mobile charging system according to an embodiment of the present disclosure, with respect to an auxiliary charging device, and FIG. 4 schematically illustrates a communication state between components of a mobile charging system according to an embodiment of the present disclosure.

As shown in FIGS. 1 and 4, a mobile charging system 10 according to an embodiment of the present disclosure includes a charging station 20, a main charging device 30, at least one auxiliary charging device 50, a user interface 80, and a control server 90. The mobile charging system 10 is configured to receive a charging demand and charge a charging demanding device 70 with the main charging device 30 alone or with a combination of the main charging device 30 and the at least one auxiliary charging device 50.

As used herein, a “main charging device” means a charging device that is connected directly to the charging demanding device, and an “auxiliary charging device” means a charging device that is connected to the charging demanding device via the main charging device or another auxiliary charging device. The main charging device and the auxiliary charging devices may be the same type of charging device and may be referred to differently depending on an object to which the charging device is connected. In other words, when one charging device is directly connected to the charging demanding device, the one charging device may be referred to as the main charging device, and when the charging device is connected to another charging device, the charging device may be referred to as the auxiliary charging device.

The charging station 20 is a stationary charging facility fixed at a predetermined location in a chargeable space, such as a parking lot, where the charging demanding device can be charged. The charging station 20 may provide one or more charging connectors or chargers to simultaneously charge the devices connected thereto. The main charging device 30, the at least one auxiliary charging device 50, or the charging demanding device 70 may be connected to the charging station 20 and charged via the charging connector or a charging socket mounted on the charging station 20. The main charging device 30 and the at least one auxiliary charging device 50 may be automatically connected to the charging station 20. In other words, when charging is required, the main charging device 30 or the at least one auxiliary charging device 50 may be automatically connected to the charging connector or the charging socket fixedly mounted on the charging station 20 through autonomous driving, and when charging is complete, the main charging device 30 or the at least one auxiliary charging device 50 may be disconnected from the charging station 20 and move to a preset waiting location or the like. A plurality of charging stations 20 may be fixedly mounted in the chargeable space.

The main charging device 30 may communicate with the control server 90 to receive charging commands and/or movement commands from the control server 90 and to transmit to the control server 90 a status of the main charging device 30 (for example, a location, a remaining power amount, or a State Of Charge (SOC) of the main charging device 30, a status of connection with other devices, or a charging information). In response to receiving the charging command and/or the movement command, the main charging device 30 may move to the charging demanding device 70, connect to the charging demanding device 70, and charge the charging demanding device 70.

As shown in FIG. 2, the main charging device 30 includes a first docking unit 32, a first connection unit 33, a first charging/discharging unit 34, a first energy storage device 36, a first driving unit 38, a first processor 40, a first movement/docking control unit 42, and a first communication unit 44.

The first docking unit 32 is mounted to the main charging device 30 and may extend from the main charging device 30. The main charging device 30 may be connected to other devices, such as the charging station 20, the charging demanding device 70, another main charging device 30, and the auxiliary charging device 50 via the first docking unit 32 to charge the other devices or receive electrical energy from the other devices via the first docking unit 32. The first docking unit 32 may be manually or automatically connected to other devices, such as the charging station 20, the charging demanding device 70, another main charging device 30, and the auxiliary charging device 50. In one example, the main charging device 30 may automatically connect the first docking unit 32 to another device via autonomous driving. In another example, the main charging device 30 is moved to a location near another device and a user may pull the first docking unit 32 from the main charging device 30 to extend the first docking unit 32 and then connect the first docking unit 32 to the other device.

The first connection unit 33 is provided on the main charging device 30, and the first connection unit 33 may be provided at a location spaced apart from the first docking unit 32 by a predetermined distance so that another device such as another main charging device 30 or the auxiliary charging device 50 may be connected to the first connection unit 33 while the main charging device 30 is connected to the charging demanding device 70 via the first docking unit 32. The main charging device 30 may receive electrical energy from another device such as another main charging device 30 or the auxiliary charging device 50 via the first connection unit 33 and transmit the received electrical energy to the charging demanding device 70 via the first docking unit 32. Optionally, the main charging device 30 may receive electrical energy from the charging station 20 via the first docking unit 32 to charge the main charging device 30 itself while simultaneously charging other devices connected to the first connection unit 33. Thus, a limited number of charging stations 20 may be used to charge multiple main charging devices 30 and auxiliary charging devices 50 during off-peak hours when the mobile charging system 10 is not heavily utilized, to prepare the case where multiple charging demanding devices 70 demand charging at the same time.

The first charging/discharging unit 34 is configured to control the charging or discharging of the first energy storage device 36. When the main charging device 30 is connected to the charging station 20 via the first docking unit 32, the first charging/discharging unit 34 receives electrical energy from the charging station 20 via the first docking unit 32 to charge the first energy storage device 36. In this example, when another device, such as another main charging device 30 or the auxiliary charging device 50, is connected to the first connection unit 33, the first charging/discharging unit 34 may transmit electrical energy to another device via the first connection unit 33. When the main charging device 30 is connected to the charging demanding device 70 via the first docking unit 32, the first charging/discharging unit 34 may control the first energy storage device 36 to discharge, thereby charging the charging demanding device 70 via the first docking unit 32.

The first energy storage device 36 is mounted within the main charging device 30. The first energy storage device 36 is configured to receive electrical energy from the charging station 20 to store the electrical energy under the control of the first charging/discharging unit 34, or is configured to discharge electrical energy to charge the charging demanding device 70.

The first driving unit 38 is mounted on the main charging device 30 and receives power from the first energy storage device 36 to cause the main charging device 30 to move. The first driving unit 38 may include, but is not limited to, at least one wheel, and at least one driving motor connected to the at least one wheel to rotate the at least one wheel. The first driving unit 38 may further include a steering device for steering the main charging device 30.

The first processor 40 is provided in the main charging device 30 and controls an overall operation of the main charging device 30. For example, in response to receiving the charging command and/or the movement command from the control server 90, the first processor 40 causes the first movement/docking control unit 42 to control the first driving unit 38 and/or the first docking unit 32, and causes the first charging/discharging unit 34 to control the charging or discharging of the first energy storage device 36. In one example, the movement command may include information about the location of the charging station 20 or the charging demanding device 70, and the first processor 40 may plan a route to the charging station 20 or the charging demanding device 70 to control the first movement/docking control unit 42 to move the main charging device 30 along the planned route. In another example, the movement command may include information about the route to the charging station 20 or the charging demanding device 70, and the first processor 40 may control the first movement/docking control unit 42 to move the main charging device 30 along the route.

The first movement/docking control unit 42 may control the first driving unit 38 to move the main charging device 30 to a target device (for example, the charging station 20 or the charging demanding device 70) and control the first docking unit 32 to be connected to the target device (for example, the charging station 20 or the charging demanding device 70).

The first communication portion 44 communicably connects the main charging device 30 with the control server 90. Accordingly, the main charging device 30 may receive the charging command and/or the movement command from the control server 90, and may transmit to the control server 90 the status of the main charging device 30 (for example, the location, the amount of remaining power amount, or the SOC of the main charging device 30, the connection status with other devices, or the charging information).

The auxiliary charging device 50 may be in communication with the control server 90 to receive the charging command and/or the movement command from the control server 90 and to transmit to the control server 90 the status of the auxiliary charging device 50 (for example, the location, the remaining power amount, or the state of charge (SOC) of the auxiliary charging device 50, or the status of connection with other devices). In response to receiving the charging command and/or the movement command, the auxiliary charging device 50 may move to the main charging device 30, be connected to the main charging device 30, and charge the charging demanding device 70 in conjunction with the main charging device 30.

As shown in FIG. 3, the auxiliary charging device 50 includes a second docking unit 52, a second connection unit 53, a second charging/discharging device 54, a second energy storage device 56, a second driving unit 58, a second processor 60, a second movement/docking control unit 62, and a second communication unit 64.

The second docking unit 52 is mounted to the auxiliary charging device 50 and may extend from the auxiliary charging device 50. The auxiliary charging device 50 may be connected via the second docking unit 52 to other devices, such as the charging station 20, the main charging device 30, the charging demanding device 70, and another auxiliary charging device 50, to transmit electrical energy to the other devices or to receive electrical energy from the other devices to charge the auxiliary charging device 50 itself or to transmit electrical energy to another device via the second docking unit 52. The second docking unit 52 may be manually or automatically connected to other devices, such as the charging station 20, the charging demanding device 70, the main charging device 30, and another auxiliary charging device 50. In one example, the auxiliary charging device 50 may be automatically connected the second docking unit 52 to another device via autonomous driving. In another example, the auxiliary charging device 50 may be moved near another device and the user may pull the second docking unit 52 from the auxiliary charging device 50 to extend the second docking unit 52 and then connect the second docking unit 52 to the other device.

The second connection unit 53 is provided on the auxiliary charging device 50. The second connection unit 53 may be provided at a location spaced apart from the second docking unit 52 by a predetermined distance so that another auxiliary charging device 50 may be connected to the second connection unit 53 while the auxiliary charging device 50 is connected to the main charging device 30 via the second docking unit 52. The auxiliary charging device 50 may receive electrical energy from another auxiliary charging device 50 via the second connection unit 53 and transmit the electrical energy to the main charging device 30 via the second docking unit 52. Optionally, the auxiliary charging device 50 may receive electrical energy from the main charging device 30 or another auxiliary charging device 50 via the second docking unit 52 to charge the auxiliary charging device 50 itself while simultaneously charging another auxiliary charging device 50 connected to the second connection unit 53. Thus, a limited number of charging stations 20 may be used to charge multiple main charging devices 30 and auxiliary charging devices 50 during off-peak hours when the mobile charging system 10 is not heavily utilized, to prepare the case where multiple charging demanding devices 70 demand charging at the same time.

The second charging/discharging device 54 is configured to control the charging or discharging of the second energy storage device 56. When the auxiliary charging device 50 is connected to the charging station 20 via the second docking unit 52, the second charging/discharging unit 54 receives electrical energy from the charging station 20 via the second docking unit 52 to charge the second energy storage device 56. In this example, when another auxiliary charging device 50 is connected to the second connection unit 53, the second charging/discharging unit 54 may transmit electrical energy to the other auxiliary charging device 50 via the second connection unit 53. When the auxiliary charging device 50 is connected to the main charging device 30 via the second docking unit 52, the second charging/discharging unit 54 may control the second energy storage device 56 to discharge, thereby transmitting electrical energy to the main charging device 30 via the second docking unit 52.

The second energy storage device 56 is mounted within the auxiliary charging device 50. The second energy storage device 56 is configured to receive electrical energy from the charging station 20 to store the received electrical energy or is configured to discharge electrical energy to transmit the electrical energy to the main charging device 30 or another auxiliary charging device 50 under control of the second charging/discharging unit 54.

The second driving unit 58 is mounted on the auxiliary charging device 50 and receives power from the second energy storage device 56 to cause the auxiliary charging device 50 to move. The second driving unit 58 may include, but is not limited to, at least one wheel, and at least one drive motor connected to the at least one wheel to rotate the at least one wheel. The second driving unit 58 may further include a steering device for steering the main charging device 30.

The second processor 60 is provided in the auxiliary charging device 50 and controls the overall operation of the auxiliary charging device 50. For example, in response to receiving at least one of the charging command or the movement command from the control server 90, the second processor 60 causes the second movement/docking control unit 62 to control at least one of the second driving unit 58 or the second docking unit 52, and causes the second charging/discharging unit 54 to control the charging or discharging of the second energy storage device 56. In one example, the movement command may include information about the location of the charging station 20, the main charging device 30, or the other auxiliary charging device 50, and the second processor 60 may plan a route to the charging station 20, the main charging device 30, or the other auxiliary charging device 50 to control the second movement/docking control unit 62 to move the auxiliary charging device 50 along the planned route. In another example, the movement command may include information about the route to the charging station 20, the main charging device 30, or another auxiliary charging device 50, and the second processor 60 may control the second movement/docking control unit 62 to move the auxiliary charging device 50 along the route.

The second movement/docking control unit 62 may control the second driving unit 58 to move the auxiliary charging device 50 to the target device (for example, the charging station 20, the main charging device 30, or another auxiliary charging device 50) and control the second docking unit 52 to be connected to the target device (for example, the charging station 20, the main charging device 30, or another auxiliary charging device 50).

The second communication portion 64 communicably connects the auxiliary charging device 50 with the control server 90. Accordingly, the auxiliary charging device 50 may receive at least one of the charging command or the movement command from the control server 90, and may transmit to the control server 90 the status of the auxiliary charging device 50 (for example, the location, the amount of remaining power amount, or the SOC of the auxiliary charging device 50, or the connection status with other devices).

As shown in FIG. 4, the user interface 80 may be mounted on the charging demanding device 70, or may be implemented in the form of an application on a user's mobile device (for example, a smartphone, a tablet computer, a personal digital assistant (PDA), or an electronic notebook computer). The user interface 80 may be communicably connected to the control server 90 such that the user interface 80 transmits a charging demand to the control server 90 and receives charging information from the control server 90. The charging demand may include at least one of location information of the charging demanding device 70, the amount of charging demanded, or an estimated stop duration. Further, the charging information may include the current SOC of the charging demanding device 70, an amount of charging per hour, an estimated time to complete charging, and the like. The user interface 80 may include a display and display the charging information on the display.

The control server 90 is communicably connected to the main charging device 30, the auxiliary charging device 50, and the user interface 80.

The control server 90 may transmit the charging command and/or the movement command to the main charging device 30 and may receive the status of the main charging device 30 from the main charging device 30. The charging command may include the amount of charging demanded, the estimated stop duration, or the like. The movement command may include the location information of the charging demanding device 70, the route to the charging demanding device 70, or the like. Further, the status of the main charging device 30 may include the location, the amount of remaining power amount, and the state of charge (SOC) of the main charging device 30, the status of connection with other devices, such as the charging station 20, the charging demanding device 70, another main charging device 30, and the auxiliary charging device 50, the charging information, and the like. Based on the status of the main charging device 30, the control server 90 determines whether to transmit the charging command and/or the movement command to the auxiliary charging device 50. The charging command and the movement command are described as separate commands, but one of the charging command and the movement command may include the other.

When the control server 90 determines that at least one of the charging command or the movement command needs to be transmitted to the auxiliary charging device 50 based on the status of the main charging device 30, the control server 90 may transmit at least one of the charging command or the movement command to the auxiliary charging device 50, and may receive the status of the auxiliary charging device 50 from the auxiliary charging device 50. The charging command may include the amount of charging demanded, the estimated stop duration, the device to which the auxiliary charging device 50 is connected (the main charging device 30 or another auxiliary charging device 50), and the like. The movement command may include the location information of the main charging device 30 or another auxiliary charging device 50 or the route to the main charging device 30 or another auxiliary charging device 50. Further, the status of the auxiliary charging device 50 may include the location, the amount of remaining power amount, and the state of charge (SOC) of the auxiliary charging device 50, the status of connection with other devices, such as the charging station 20, the main charging device 30, another auxiliary charging device 50, the charging information, and the like. Based on the status of the auxiliary charging device 50, the control server 90 determines whether to transmit the charging command and/or the movement command to another auxiliary charging device 50.

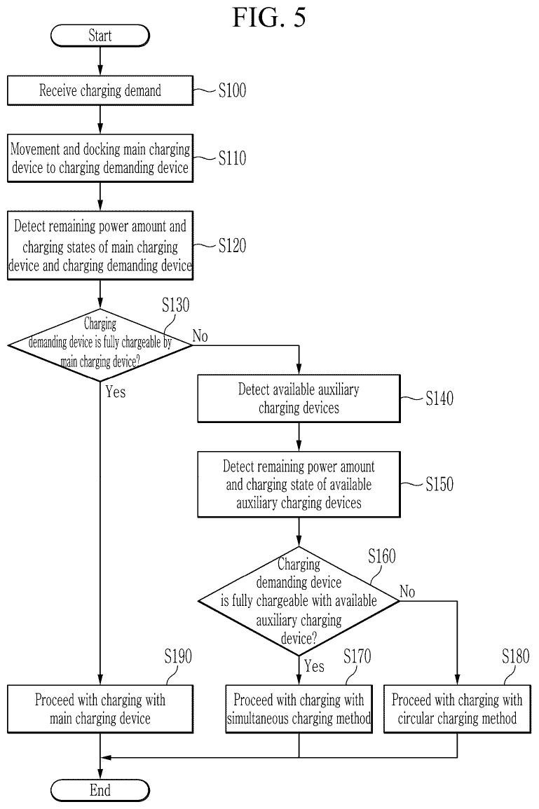

Hereinbelow, a mobile charging method according to an embodiment of the present disclosure has been described in detail with reference to FIG. 5.

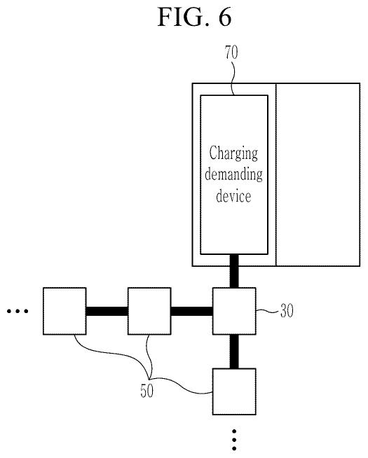

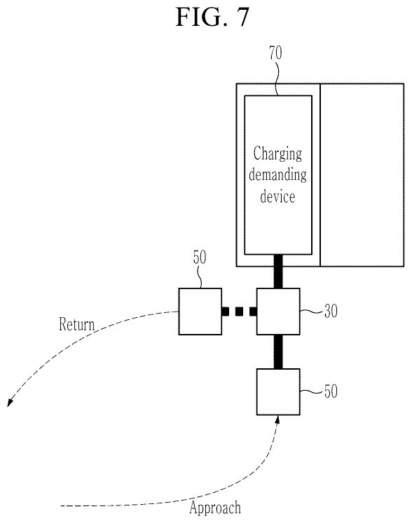

FIG. 5 is a flow diagram of a mobile charging method according to an embodiment of the present disclosure. FIG. 6 is a diagram illustrating a simultaneous charging method according to an embodiment of the present disclosure. FIG. 7 is a diagram illustrating a circular charging method according to an embodiment of the present disclosure.

As shown in FIG. 5, a mobile charging method according to an embodiment of the present disclosure begins with a user sending the charging demand to the control server 90 via the user interface 80. The control server 90 receives the charging demand, which includes at least one of the location information of the charging demanding device 70, the amount of charging demanded, or the estimated stop duration at step S100, and transmits at least one of the charging command or the movement command to the main charging device 30 to move and dock the main charging device 30 to the charging demanding device 70 at step S110. The charging command may include the amount of charging demanded, the estimated stop duration, or the like. The movement command may include the location information of the charging demanding device 70 or the route to the charging demanding device 70, or the like. When the mobile charging system 10 includes a plurality of main charging devices 30, the mobile charging system 10 may receive the status of the main charging devices 30 prior to step S110, and select the main charging device 30 to charge the charging demanding device 70 based on the status of the main charging devices 30. However, receiving the status of the main charging devices 30 and selecting the main charging device 30 to charge the charging demanding device 70 is not a required step, but merely an optional step.

When the main charging device 30 has docked with the charging demanding device 70, the first processor 40 detects at least one of the remaining power amount or the state of charge (SOC) of at least one of the main charging device 30 or the charging demanding device 70 at step S120. The first processor 40 determines whether the charging demanding device can be fully charged by the main charging device 30 alone, based on at least one of the remaining power amount or the SOC of at least one of the main charging device 30 or the charging demanding device 70, and the amount of charging demanded included in the charging command at step S130. For example, the first processor 40 may compare the remaining power amount of the main charging device 30 to the amount of charging demanded to determine whether the charging demanding device 70 can be fully charged using the main charging device 30 alone.

At step S130, when it is determined that the charging demanding device 70 can be fully charged with the main charging device 30 alone, the first processor 40 controls the first charging/discharging unit 34 to charge the charging demanding device 70 with the main charging device 30 alone at step S190.

When it is determined that that the charging demanding device 70 cannot be fully charged with the main charging device 30 alone at step S130, the control server 90 detects available auxiliary charging devices 50 at step S140. For example, the control server 90 may detect the auxiliary charging devices 50 that are not connected to other devices, such as the charging station 20, the main charging device 30, and other auxiliary charging devices 50, based on the status of the corresponding auxiliary charging device 50 received from the corresponding auxiliary charging device 50. In this example, additionally or alternatively, the first processor 40 may control the first charging/discharging unit 34 to initiate charging of the charging demanding device 70 with the main charging device 30.

When the control server 90 has detected the available auxiliary charging devices 50, the control server 90 detects the remaining power amount and/or the SOC of the available auxiliary charging devices 50 at step S150. For example, the second processors 60 of the available auxiliary charging devices 50 may detect the remaining power amount and/or the SOC of the corresponding auxiliary charging device 50, and transmit the remaining power amount and/or the SOC of the auxiliary charging devices 50 to the control server 90, and the control server 90 may detect the remaining power amount and/or the SOCs of the available auxiliary charging devices 50.

The control server 90 determines whether the charging demanding device 70 can be fully charged with the available auxiliary charging devices 50 based on at least one of the remaining power amount or the SOCs of the available auxiliary charging devices 50 at step S160. For example, the control server 90 may compare the remaining power amount of the main charging device 30 to the amount of charging demanded to detect an insufficient charging amount, and compare the remaining power amount of the available auxiliary charging devices 50 to the insufficient charging amount to determine whether the charging demanding device 70 can be fully charged with the available auxiliary charging devices 50.

When it is determined that the charging demanding device 70 can be fully charged with the available auxiliary charging devices 50 at step S160, the control server 90 proceeds to charge the charging demanding device 70 in a simultaneous charging method at step S170. The simultaneous charging method means that the main charging device 30 and the required auxiliary charging device 50 are connected to each other to simultaneously charge the charging demanding device 70. For example, as shown in FIG. 6, the control server 90 may detect the available auxiliary charging devices 50 that are needed to fully charge the charging demanding device 70, transmit at least one of the charging commands or the movement commands to the detected auxiliary charging devices 50 to connect the auxiliary charging devices 50 to at least one of the main charging device 30 or other auxiliary charging devices 50 in a serial or parallel manner, and simultaneously charge the charging demanding device 70 by using the connected main charging device 30 and auxiliary charging devices 50. Accordingly, the duration demanded to charge the charging demanding device 70 may be reduced.

When it is determined that the charging demanding device 70 cannot be fully charged with the available auxiliary charging devices 50 at step S160, the control server 90 proceeds to charge the charging demanding device 70 in a circular charging method at step S180. The circular charging method means, as illustrated in FIG. 7, that in the state where the main charging device 30 is connected to the charging demanding device 70 to proceed charging, one auxiliary charging device 50 is connected to the main charging device 30 to charge the charging demanding device 70 together, and then the one auxiliary charging device 50 is disconnected from the main charging device 30 and the other auxiliary charging device 50 is connected to the main charging device 30 to charge the charging demanding device 70 together. In other words, when it is determined that the charging demanding device 70 cannot be charged by using the available auxiliary charging devices 50 at the same time, the mobile charging system 10 connects some of the auxiliary charging devices 50 to the main charging device 30 to proceed with charging the charging demanding device 70, while moving other auxiliary charging devices 50 to the charging station 20 to charge other auxiliary charging devices 50. Thereafter, the mobile charging system 10 disconnects some of the auxiliary charging devices 50 from the main charging device 30 and moves the disconnected auxiliary charging devices 50 to the charging station 20, and connects other auxiliary charging devices 50 to the main charging device 30 to proceed with charging the charging demanding device 70. The auxiliary charging devices 50 alternately participate in charging the charging demanding devices 70, so that the time demanded to charge the charging demanding devices 70 is somewhat increased, but the charging demanding devices 70 can be fully charged with the limited number of the main charging devices 30 and the auxiliary charging devices 50, even when multiple charging demanding devices 70 demand charging at the same time.

While this disclosure has been described in connection with what is presently considered to be practical embodiments, it is to be understood that the present disclosure is not limited to the disclosed embodiments. On the contrary, it is intended to cover various modifications and equivalent arrangements included within the spirit and scope of the appended claims.

What is claimed is:

1. A mobile charging system comprising:
a charging station fixedly mounted at a predetermined location in a charging space that allows a charging demanding device to be located therein for charging;
a main charging device including:
a first energy storage device configured to store electrical energy or discharge the stored electrical energy, and
a first driving unit providing locomotion by using the electrical energy stored in the first energy storage device, wherein the main charging device is configured to be connected to the charging station to store electrical energy of the charging station in the first energy storage device or to be connected to the charging demanding device to charge the charging demanding device with the electrical energy stored in the first energy storage device;
at least one auxiliary charging device including:
a second energy storage device configured to store electrical energy or discharge the stored electrical energy, and
a second driving unit providing locomotion by using the electrical energy stored in the second energy storage device, wherein the at least one auxiliary charging device is configured to be connected to the charging station to store the electrical energy of the charging station in the second energy storage device or connected to the main charging device to charge the charging demanding device with the electrical energy stored in the second energy storage device via the main charging device; and
a control server communicably connected to the main charging device and the at least one auxiliary charging device and configured to transmit a charging command to the main charging device to move the main charging device to the charging demanding device and charge the charging demanding device.

2. The mobile charging system of claim 1, wherein the control server is further configured to:
in response to receiving a status of the main charging device from the main charging device, determine whether the charging demanding device is fully chargeable by the main charging device alone; and,
in response to determining that the charging demanding device is not fully chargeable by the main charging device alone, transmit the charging command to the at least one auxiliary charging device to move the at least one auxiliary charging device to the main charging device and charge the charging demanding device via the main charging device.

3. The mobile charging system of claim 2, wherein the control server is further configured to:
detect an available auxiliary charging device prior to transmitting the charging command to the at least one auxiliary charging device;
determine whether the charging demanding device is fully chargeable with the available auxiliary charging device; and
in response to determining that the charging demanding device is fully chargeable with the available auxiliary charging device, proceed with a simultaneous charging method in which the at least one available auxiliary charging device is simultaneously engaged in charging.

4. The mobile charging system of claim 3, wherein the control server is further configured to proceed with a circular charging method in which the at least one available auxiliary charging device is sequentially engaged in charging in response to determining that the charging demanding device is not fully chargeable by the available auxiliary charging device.

5. The mobile charging system of claim 1, further comprising:
a user interface communicably connected to the control server to be configured to transmit a charging demand to the control server and to receive charging information from the control server.

6. The mobile charging system of claim 5, wherein the user interface is further configured to display the charging information received from the control server.

7. The mobile charging system of claim 1, wherein the main charging device further includes:
a first docking unit mounted to the main charging device and connectable to the charging station or the charging demanding device, the first docking unit configured to extend from the main charging device; and
a first connection unit provided on the main charging device and spaced apart from the first docking unit to allow the at least one auxiliary charging device to be connected in a state where the main charging device is connected to the charging demanding device via the first docking unit.

8. The mobile charging system of claim 7, wherein the first docking unit is automatically or manually connectable to the charging station or the charging demanding device.

9. The mobile charging system of claim 1, wherein each auxiliary charging device further includes:
a second docking unit mounted to an auxiliary charging device and connectable to the charging station, the main charging device, or another auxiliary charging device, the second docking unit configured to extend from the auxiliary charging device; and
a second connection unit provided on the auxiliary charging device and spaced apart from the second docking unit to allow another auxiliary charging device to be connected in a state where the auxiliary charging device is connected to the main charging device or another auxiliary charging device via the second docking unit.

10. The mobile charging system of claim 9, wherein the second docking unit is automatically or manually connectable to the charging station, the main charging device, or another auxiliary charging device.

11. The mobile charging system of claim 1, wherein the main charging device or the at least one auxiliary charging device is configured to autonomously drive.

12. A mobile charging method comprising:
receiving, by a control server, a charging demand including at least one of location information or an amount of charging demanded of a charging demanding device;
moving and docking a main charging device to the charging demanding device by transmitting, by the control server, a charging command including at least one of the location information or the amount of charging demanded of the charging demanding device;
determining, by the main charging device or the control server, whether the main charging device alone is capable of fully charging the charging demanding device;
detecting, by the control server, an available auxiliary charging device in response to determining that the main charging device alone is not capable of fully charging the charging demanding device; and
charging the charging demanding device with the available auxiliary charging device via the main charging device by transmitting, by the control server, the charging command including location information of the main charging device to the available auxiliary charging device.

13. The mobile charging method of claim 12, wherein charging the charging demanding device with the available auxiliary charging device via the main charging device includes:
determining whether the charging demanding device is fully chargeable with the available auxiliary charging device; and
in response to determining that the charging demanding device is fully chargeable with the available auxiliary charging device, proceeding with a simultaneous charging method in which the at least one available auxiliary charging device is simultaneously engaged in charging.

14. The mobile charging method of claim 13, wherein proceeding with a simultaneous charging method includes:
selecting the available auxiliary charging device required to fully charge the charging demanding device; and
connecting the selected available auxiliary charging device to the main charging device or another selected available auxiliary charging device to allow the main charging device and the selected available auxiliary charging device to simultaneously charge the charging demanding device.

15. The mobile charging method of claim 13, wherein charging the charging demanding device with the available auxiliary charging device via the main charging device further includes, in response to determining that the charging demanding device is not fully chargeable with the available auxiliary charging device, proceeding with a circular charging method in which the at least one available auxiliary charging device is sequentially engaged in charging.

16. The mobile charging method of claim 15, wherein proceeding with a circular charging method includes:
connecting the at least one available auxiliary charging device to the main charging device or another available auxiliary device connected to the main charging device to charge the charging demanding device with the main charging device and the at least one available auxiliary charging device;
disconnecting the at least one available auxiliary charging device from the main charging device or the another available auxiliary device connected to the main charging device; and
connecting at least one other available auxiliary charging device to the main charging device or the another available auxiliary device connected to the main charging device to charge the charging demanding device with the main charging device and the at least one other available auxiliary charging device.

17. The mobile charging method of claim 12, further comprising:
transmitting the charging demand to the control server by a user interface communicably connected with the control server; and
receiving, by the user interface, charging information from the control server.

18. The mobile charging method of claim 17, further comprising:
displaying, by the user interface, the charging information received from the control server.

19. The mobile charging method of claim 12, wherein the main charging device or the at least one auxiliary charging device is configured to autonomously drive.
